(19) United States
(12) Patent Application Publication
(10) Pub. No.: US 2011/0101797 A1
(43) Pub. Date: May 5, 2011

(54) VIBRATION MOTOR

(75) Inventors: Kyoung-Ho LEE, Suwon-si (KR); Hwa-Young Oh, Seoul (KR); Jee-Sung Lee, Suwon-si (KR); Seok-Jun Park, Suwon-si (KR); Je-Hyun Bang, Suwon-si (KR); Kwang-Hyung Lee, Suwon-si (KR); Yong-Jin Kim, Suwon-si (KR); Jun-Kun Choi, Suwon-si (KR)

(73) Assignee: SAMSUNG ELECTRO-MECHANICS CO., LTD.

(21) Appl. No.: 12/726,093

(22) Filed: Mar. 17, 2010

(30) Foreign Application Priority Data
Nov. 2, 2009 (KR) 10-2009-0104783

(51) Int. Cl. H02K 33/00

(52) U.S. Cl. 310/29

(57) ABSTRACT

A vibration motor is disclosed. In accordance with an embodiment of the present invention, the vibration motor includes a base, a vibrator, which reciprocates, a coupling part, which is protruded on at least one of the base and the vibrator, and a leaf spring, which includes a frame and an elastic part. Here, the frame is coupled to the coupling part and disposed apart from the base or the vibrator in which the coupling part is formed, and the elastic part is extended from the frame and elastically supports the vibrator. Thus, the leaf spring can be prevented from having concentrated stress and damage occurred, thereby improving the lifetime of the leaf spring.

### CROSS-REFERENCE TO RELATED APPLICATIONS

This application claims the benefit of Korean Patent Application No. 10-2009-0104783, filed with the Korean Intellectual Property Office on Nov. 2, 2009, the disclosure of which is incorporated herein by reference in its entirety.

### BACKGROUND

1. Technical Field

The present invention is related to a vibration motor.

2. Description of the Related Art

A vibration motor is a part that converts electrical energy into mechanical vibrations by using the principle of generating electromagnetic forces, and is commonly installed in a mobile phone to generate a soundless vibrating alert. With the rapid expansion of mobile phone markets and increased functionalities added to the mobile phone, mobile phone parts are increasingly required to be smaller and better. As a result, there has been an increased demand for the development of a new structure of vibration motor that can improve the shortcoming of conventional vibration motors and effectively improve the quality.

As mobile phones having a bigger LCD screen have become popular for the past few years, there have been an increasing number of mobile phones adopting a touch-screen method, by which vibration is generated when the screen is touched. Touch-screens particularly require that the vibration motor has a greater durability due to a greater frequency of generating vibration in response to the touch, compared to the vibration bell for incoming calls and that the vibration has a faster response to the touch made on the touch screen, in order to provide a user a greater satisfaction from sensing the vibration when touching the touch screen.

Commonly used to overcome the drawbacks of shorter life time and slower responsiveness in the vibration functionality of touchscreen phones is a liner vibration motor, which does not use the principle of rotating a motor but uses an electromagnetic force having a predetermined resonant frequency to generate vibrations by use of a spring installed in the vibration motor and a mass coupled to the spring. In the linear vibration motor, the electromagnetic force is generated through an interactive reaction between a magnet, which is placed on a moving part, and a direct or alternating current having a particular frequency flowing through a coil, which is placed on a stationary part.

Here, a leaf spring can be used as the spring for the liner vibration motor. In the conventional leaf spring, however, stresses are concentrated where a portion contacted by and coupled to a supporting part, such as a base, and a portion elastically supporting a moving part and being deformed are connected, thereby possibly damaging the leaf spring.

### SUMMARY

The present invention provides a vibration motor that can prevent a concentrated stress from occurring at the leaf spring and avoid a damage caused by the stress.

An aspect of the present invention provides a vibration motor that includes a base, a vibrator, which reciprocates, a coupling part, which is protruded on at least one of the base and the vibrator, and a leaf spring, which includes a frame and an elastic part. Here, the frame is coupled to the coupling part and disposed apart from the base or the vibrator in which the coupling part is formed, and the elastic part is extended from the frame and elastically supports the vibrator.

The coupling part can include a supporting protrusion and a coupling protrusion, in which the supporting protrusion supports the frame such that the leaf spring is apart from the base or the vibrator and the coupling protrusion is protruded from the supporting protrusion, and a penetration part is formed in the frame of the leaf spring, in which the coupling protrusion is inserted into the penetration part.

There can be a plurality of leaf springs, and the plurality of leaf springs can be disposed to face one another in such a way that an elastic part thereof is coupled to another elastic part thereof.

There can be a plurality of leaf springs, and each of the plurality of leaf springs can be interposed between either end of the vibrator and the base.

The base can include a pair of supporting parts facing each other, and the plurality of leaf springs can be interposed between the pair of supporting parts and the vibrator.

The vibration motor can further include a coil unit in a hollow cylindrical shape, in which the coil unit is disposed in the base, and the vibrator can further include a magnet and a weight, in which the magnet is inserted into the coil unit and the weight is coupled to the magnet.

The vibrator can include a side yoke, which covers at least one side of the weight and in which the coupling part is formed in at least one end part of the side yoke.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is an exploded perspective view of a vibration motor in accordance with an embodiment of the present invention.

FIG. 2 is a perspective view of a vibration motor in accordance with an embodiment of the present invention.

FIG. 3 is a plan view of a vibration motor in accordance with an embodiment of the present invention.

FIG. 4 is a magnified view illustrating coupling of a coupling part and a leaf spring of a vibration motor in accordance with an embodiment of the present invention.

FIG. 5 is a perspective view illustrating a coupling part of a vibration motor in accordance with an embodiment of the present invention.

FIG. 6 is a perspective view illustrating a leaf spring of a vibration motor in accordance with an embodiment of the present invention.

FIG. 7 illustrates the result of a simulation for testing the stress analysis of a leaf spring in a vibration motor in accordance with the related art.

FIG. 8 illustrates the result of a simulation for testing the stress analysis of a leaf spring in a vibration motor in accordance with an embodiment of the present invention.

FIG. 9 is a table comparing the maximum stress and lifetime of a leaf spring in a vibration motor in accordance with the related art and a vibration motor in accordance with an embodiment of the present invention.

### DETAILED DESCRIPTION

The features and advantages of this invention will become apparent through the below drawings and description.

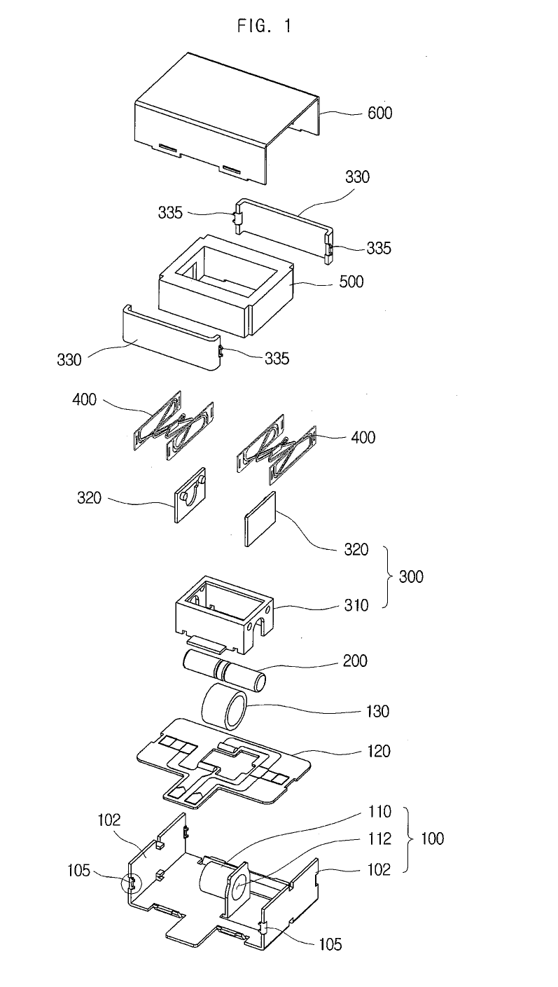

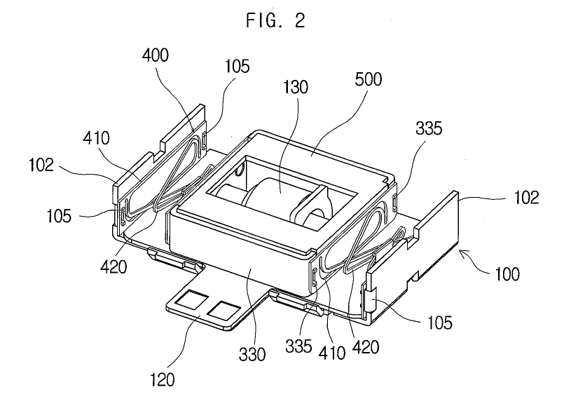

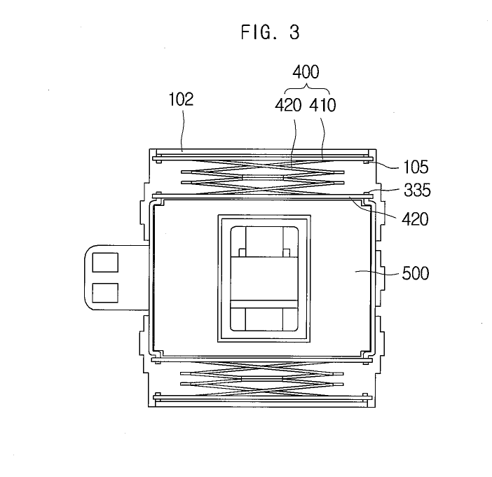

FIG. 1 is an exploded perspective view of a vibration motor in accordance with an embodiment of the present invention; FIG. 2 is a perspective view of a vibration motor in accordance with an embodiment of the present invention; and FIG. 3 is a plan view of a vibration motor in accordance with an embodiment of the present invention.

A vibration motor in accordance with an embodiment of the present invention includes a base 100, a vibrator, coupling parts 105 and 335 and a leaf spring 400. A coil unit 130 is disposed in the base 100, and the vibrator can be constituted by a magnet 200, a weight 500 and a yoke 300.

The base 100 is a part that supports the vibrator, which will be described later, to vibrate. In this embodiment, the base 100 can have a space in which components constituting the vibration motor can be housed. The coil unit 130, which will be described later, is disposed in the center of the base 100. To interpose the leaf spring 400, which will be described later, between both ends of the vibrator and the base 100, a pair of supporting parts 102 facing each other can be also formed at both ends of the base 100.

More specifically, the base 100 of the present embodiment can have a bobbin 110 that can support the coil unit 130, and the bobbin 110 can have a cylindrical shape having a hollow part 112 formed therein. The pair of supporting parts 102 are formed in a shape of a pair of facing partition walls at both ends of the base 100. Accordingly, the leaf spring 400, which will be described later, can be interposed between the pair of supporting parts and the vibrator.

Meanwhile, coupled to the base 100 can be a case 600, which covers the base 100 and forms the exterior of the vibration motor.

The coil unit 130, which is a part that generates an electromagnetic force needed for vibrations, is wound with a coil to form a cylindrical shape having a hollow part therein. As such, by inserting the bobbin 110 into the hollow part of the coil unit 130, the coil unit 130 can be installed in the base 102.

A substrate 120 is a part that provides electrical connection to the coil unit 130. A circuit pattern is formed on one surface of the substrate 120. The substrate 120 is installed on the base 100, and the bobbin 110 can be exposed toward an upper side of the base 100 through an opening formed in the center of the substrate 120.

The vibrator is a part that is reciprocated inside the vibration motor for generating vibrations and can be vibrated by the electromagnetic force of the coil unit 130. In this embodiment, the vibrator includes a magnet 200, a weight 500 and a yoke 300.

The magnet 200 is made of a magnetic material that generates a force by the electromagnetic force of the coil unit 130, and can have a cylindrical shape extended lengthwise. By being inserted into the hollow part of the bobbin 110, the magnet 200 can move horizontally in the hollow part of the bobbin 110.

The yoke 300 prevents the leakage of magnetic flux of the magnet 200 and converges the magnetic flux. The yoke 300 includes a cover yoke 310, a back yoke 320 and a side yoke 330. The cover yoke 310 can be shaped as a rectangular cuboid generally surrounding the magnet 200. The back yoke 320 can be coupled to both ends of the magnet 200 and the cover yoke 310.

In addition, the side yoke 330 covers a side of the weight 500, which will be described later. Here, a coupling part 335, which will be described later, can be formed in at least one end part of the side yoke 330 in such a way that the leaf spring 400, which will be described later, can be coupled to the vibrator of the present embodiment.

The weight 500 is formed in the shape of a rectangular cuboid generally surrounding the magnet 200. The weight 500 is installed on the outside of the magnet 200 and the cover yoke 310 and can generate strong vibrations through repetitive horizontal movements together with the magnet 200.

The coupling parts 105 and 335 are protruded on at least one of the base 100 and the vibrator and couple the leaf spring 400, which will be described later, to at least one of the base 100 and the vibrator. Particularly, in this embodiment, the coupling parts 105 and 335 support a frame 410 of the leaf spring 400 by separating the frame 410 of the leaf spring 400 from the base 100 or the vibrator in such a way that the leaf spring 400 is not in direct contact with the base 100 or the vibrator.

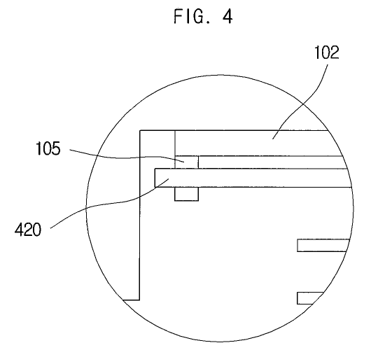

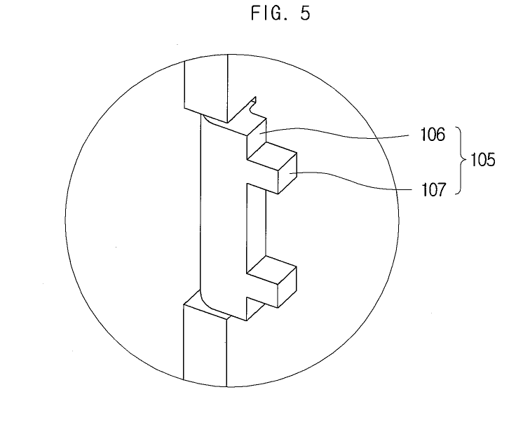

FIG. 4 is a magnified view illustrating coupling of a coupling part and a leaf spring of a vibration motor in accordance with an embodiment of the present invention, and FIG. 5 is a perspective view illustrating a coupling part of a vibration motor in accordance with an embodiment of the present invention.

In this embodiment, as illustrated in FIGS. 3 to 5, the coupling parts 105 and 335 are formed in the pair of supporting parts 102 of the base 100 and the side yoke of the vibrator, to which the leaf spring 400 is coupled. Here, the coupling parts 105 and 335 can include a supporting protrusion 106 that supports the frame 410 so as to separate the leaf spring 400 from the base 100 or the vibrator.

This arrangement makes it possible to separate portions of the leaf spring 400, excluding a portion of the frame 410 coupled to the coupling parts 105 and 335, from the base 100 or the vibrator. As a result, the movement of the frame 410 is not restricted by the base 100 or the vibrator.

The coupling parts 105 and 335 can also include a coupling protrusion 107 protruded from the supporting protrusion 106, and a penetration part, into which the coupling protrusion 107 is inserted, can be formed in the frame 410 of the leaf spring 400. As such, a location at which the leaf spring 400 is coupled can be accurately determined by the coupling protrusion 107.

The leaf spring 400 is a part that elastically supports the vibrator in such a way that the vibrator can vibrate. For this, the leaf spring 400 is interposed between the base 100 and the vibrator.

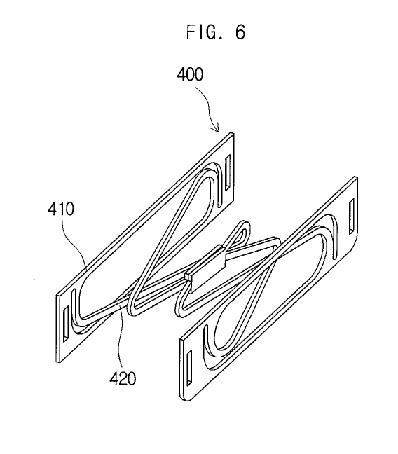

FIG. 6 is a perspective view illustrating a leaf spring of a vibration motor in accordance with an embodiment of the present invention.

As illustrated in FIG. 6, the leaf spring 400 includes the frame 410, which is coupled to the coupling parts 105 and 335, and an elastic part 420 that is extended from the frame 410 and elastically supports the vibrator by being elastically deformed.

Particularly, as described above, in the leaf spring 400 of the present embodiment, the frame 410 can be disposed apart from the base 100 or the vibrator such that the leaf spring 400 is not in direct contact with the base 100 or the vibrator. In this way, the movement of the frame 410 is not restricted by the base 100 or the vibrator, and thus the stress may not be concentrated where the frame 410 and the elastic part 420 meet, even though the elastic part 420 is deformed.

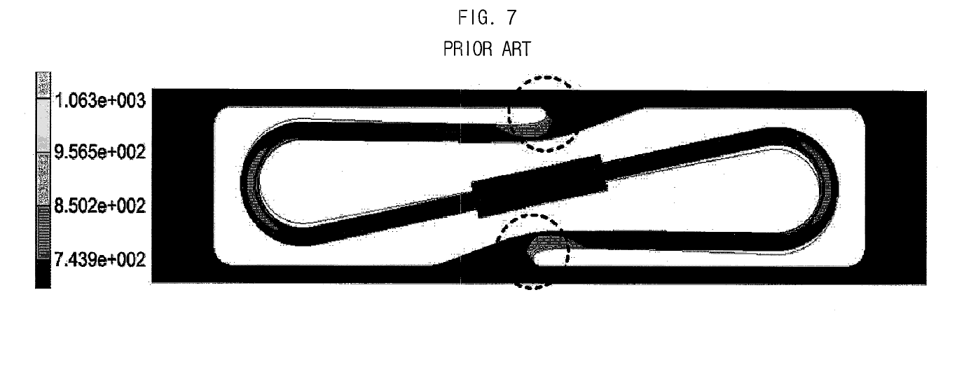

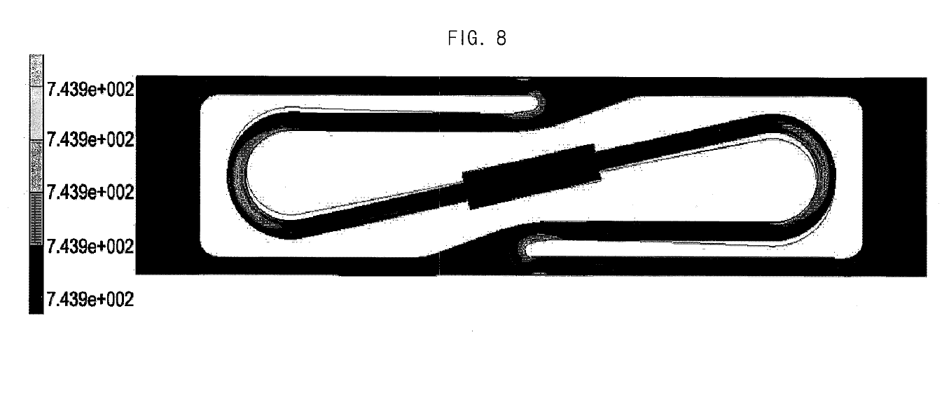

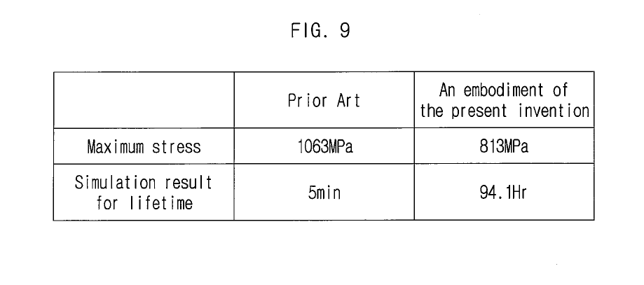

FIG. 7 illustrates the result of a simulation for testing the stress analysis of a leaf spring in a vibration motor in accordance with the related art, and FIG. 8 illustrates the result of a simulation for testing the stress analysis of a leaf spring in a vibration motor in accordance with an embodiment of the present invention. FIG. 9 is a table comparing the maximum stress and lifetime of a leaf spring in a vibration motor in accordance with the related art and a vibration motor in accordance with an embodiment of the present invention.

In the present embodiment, as illustrated in FIGS. 7 to 9, the frame 410 is capable of accommodating the deformation of the elastic part 420 because the frame 410 is apart from the base 100 or the vibrator, allowing the frame 410 to freely move. As a result, the phenomenon of stresses being concentrated where the frame 410 and the elastic part 420 meet can be mitigated. Accordingly, the leaf spring 400 can be prevented from having concentrated stress and damage occurred, thereby improving the lifetime of the leaf spring.

Here, a plurality of leaf springs 400 can be coupled together to support the vibrator. More specifically, as illustrated in FIG. 6, the plurality of leaf springs 400 can be disposed to face each other in such a way that the elastic part 420 thereof can be coupled to another elastic part.

The modulus of elasticity of a leaf spring assembly in which the plurality of leaf springs 400 are coupled to one another can become smaller than that of each leaf spring 400. Accordingly, the leaf spring 400 having an even greater modulus of elasticity can be used, and thus a wider variety of elastic moduli of the leaf spring 400 can be selected when designing the vibration motor, ultimately improving the design freedom.

Furthermore, since the leaf spring 400 having a greater modulus of elasticity can be used, an even thicker leaf spring 400 can be used. As a result, the stiffness of the leaf spring 400 can be increased. Thus, it is easier to handle the leaf spring 400 during the manufacturing process, thereby effectively reducing the dispersion of the modulus of elasticity of the leaf spring 400.

Also, since the plurality of leaf springs 400 are used, the range of displacement that the leaf spring assembly has can be increased so that the amount of vibration in the vibration motor can also be increased.

While the spirit of the present invention has been described in detail with reference to a particular embodiment, the embodiment is for illustrative purposes only and shall not limit the present invention. It is to be appreciated that those skilled in the art can change or modify the embodiment without departing from the scope and spirit of the present invention.

As such, many embodiments other than that set forth above can be found in the appended claims.

What is claimed is:

1. A vibration motor comprising:
a base;
a vibrator that reciprocates;
a coupling part protruded on at least one of the base and the vibrator; an
a leaf spring comprising a frame and an elastic part, the frame being coupled to the coupling part and disposed apart from the base or the vibrator in which the coupling part is formed, the elastic part being extended from the frame and elastically supporting the vibrator.

2. The vibration motor of claim 1, wherein:
the coupling part comprises a supporting protrusion and a coupling protrusion, the supporting protrusion supporting the frame such that the leaf spring is apart from the base or the vibrator, the coupling protrusion being protruded from the supporting protrusion; and
a penetration part is formed in the frame of the leaf spring, the coupling protrusion being inserted into the penetration part.

3. The vibration motor of claim 1, wherein there are a plurality of leaf springs, and the plurality of leaf springs are disposed to face one another in such a way that an elastic part thereof is coupled to another elastic part thereof.

4. The vibration motor of claim 1, wherein there are a plurality of leaf springs, and each of the plurality of leaf springs is interposed between either end of the vibrator and the base.

5. The vibration motor of claim 4, wherein the base comprises a pair of supporting parts facing each other, and the plurality of leaf springs are interposed between the pair of supporting parts and the vibrator.

6. The vibration motor according to any one of claims 1 to 5, further comprising a coil unit in a hollow cylindrical shape, the coil unit being disposed in the base,
wherein the vibrator further comprises a magnet and a weight, the magnet being inserted into the coil unit, the weight being coupled to the magnet.

7. The vibration motor of claim 5, wherein the vibrator comprises a side yoke covering at least one side of the weight, the coupling part being formed in at least one end part of the side yoke.
